(19) United States
(12) Patent Application Publication
(10) Pub. No.: US 2025/0071851 A1
(43) Pub. Date: Feb. 27, 2025

(54) METHOD AND APPARATUS OF SUPPORTING MULTICAST AND BROADCAST SERVICES (MBS)

(71) Applicant: LENOVO (BEIJING) LIMITED, Beijing (CN)

(72) Inventors: Mingzeng DAI, Shanghai (CN); Jing HAN, Beijing (CN); Lianhai WUY, Beijing (CN); Congchi ZHANG, Shanghai (CN)

(21) Appl. No.: 18/725,385

(22) PCT Filed: Dec. 31, 2021
(86) PCT No.: PCT/CN2021/143817

§ 371 Date: Jun. 28, 2024

(51) Int. Cl. H04W 76/27; H04W 76/40

(52) U.S. Cl. CPC H04W 76/27; H04W 76/40

(57) ABSTRACT

Embodiments of the present application relate to a method and apparatus of supporting multicast and broadcast services (MBS). An exemplary method includes: receiving by a user equipment (UE), configuration information on at least one condition parameter associated with radio resource control (RRC) state transition for multicast reception; and triggering a RRC connection resume procedure by the UE to enter a RRC connected state from a RRC inactive state in response to that the at least one condition parameter is fulfilled in the case that the UE is receiving multicast or is configured to receive the multicast in the RRC inactive state.

### TECHNICAL FIELD

Embodiments of the present application generally relate to wireless communication technology, especially to a method and apparatus of supporting multicast and broadcast services (MBS).

### BACKGROUND

In new radio (NR) release (R) 17, MBS plans to focus on a small area mixed mode multicast (also referred to as Objective A in the TR 23.757). The Objective A is about enabling general MBS services over 5G system (5GS) and the identified use cases that could benefit from this feature. These use cases include but are not limited to: public safety and mission critical, vehicle to everything (V2X) applications, transparent internet protocol version 4 (IPv4)/internet protocol version 6 (IPv6) multicast delivery, internet protocol television (IPTV), software delivery over wireless, group communications and internet of things (IoT) applications.

Meanwhile, the work item on NR support of MBS was also agreed in R17 (e.g., RP-201038), wherein MBS reception in all radio resource control (RRC) states, i.e., RRC_IDLE state, RRC_INACTIVE state and RRC_CONNECTED state should be supported. However, various issues, e.g., service interruption, data loss, or large delay etc., will happen during the transition between different RRC states. Taking multicast reception as an example, it is only supported in RRC_CONNECTED state in R17. When a user equipment (UE) transits from RRC_CONNECTED state to RRC_INACTIVE state or RRC_IDLE state, it cannot receive multicast, e.g., multicast session(s) or multicast radio bearer(s).

Thus, an improved technical solution for MBS considering RRC state transition, e.g., how to support multicast reception in RRC_INACTIVE state should be seriously considered.

### SUMMARY OF THE DISCLOSURE

One objective of the present application is to provide a method and apparatus of supporting MBS, especially supporting multicast reception in RRC_INACTIVE state.

Some embodiments of the present application provide an exemplary apparatus, e.g., a UE, which includes: a transceiver and at least one processor coupled to the transceiver. The at least one processor is configured to: receive, via the transceiver, configuration information on at least one condition parameter associated with RRC state transition for multicast reception; and trigger a RRC connection resume procedure to enter a RRC connected state from a RRC inactive state in response to that the at least one condition parameter is fulfilled in the case that the UE is receiving multicast or is configured to receive the multicast in the RRC inactive state.

Some embodiments of the present application provide an exemplary method, which includes: receiving by a UE, configuration information on at least one condition parameter associated with RRC state transition for multicast reception; and triggering a RRC connection resume procedure by the UE to enter a RRC connected state from a RRC inactive state in response to that the at least one condition parameter is fulfilled in the case that the UE is receiving multicast or is configured to receive the multicast in the RRC inactive state.

In some embodiments of the present application, the at least one condition parameter includes a radio link quality threshold and a state transition timer associated with the radio link quality threshold, and the RRC connection resume procedure is triggered in the case that: radio link quality of a serving cell of the UE is lower than or equal to the radio link quality threshold for a time interval of the state transition timer.

In some embodiments of the present application, the at least one condition parameter includes: a radio link quality threshold and at least one scaling factor associated with the radio link quality threshold, and the RRC connection resume procedure is triggered in the case that: radio link quality of a serving cell of the UE is lower than or equal to the radio link quality threshold multiplied by a scaling factor of the at least one scaling factor, wherein the scaling factor is network load dependent or is UE mobility speed dependent.

In some embodiments of the present application, the at least one condition parameter includes: a radio link quality threshold, a state transition timer and at least one scaling factor associated with the radio link quality threshold, and the RRC connection resume procedure is triggered in the case that: radio link quality of a serving cell of the UE is lower than or equal to the radio link quality threshold multiplied by a scaling factor of the at least one scaling factor for a time interval of the state transition timer, wherein, the scaling factor is network load dependent or is UE mobility speed dependent.

In some embodiments of the present application, the at least one condition parameter includes: a radio link quality threshold, a state transition timer and at least one scaling factor associated with the state transition timer, and the RRC connection resume procedure is triggered in the case that: radio link quality of a serving cell of the UE is lower than or equal to the radio link quality threshold for a time interval of the state transition timer multiplied by a scaling factor of the at least one scaling factor, wherein, the scaling factor is network load dependent or is UE mobility speed dependent.

In some embodiments of the present application, the at least one condition parameter includes: a radio link quality threshold, at least one first scaling factor associated with the radio link quality threshold, a state transition timer and at least one second scaling factor associated with the state transition timer, and the RRC connection resume procedure is triggered in the case that: radio link quality of a serving cell of the UE is lower than or equal to the radio link quality threshold multiplied by a first scaling factor of the at least one first scaling factor for a time interval of the state transition timer multiplied by a second scaling factor of the at least one second scaling factor, wherein the first scaling factor and the second scaling factor are network load dependent or UE mobility speed dependent.

In some embodiments of the present application, the at least one condition parameter includes: a radio link quality threshold and at least one offset value associated with the radio link quality threshold, each of the at least one offset value is associated with a multicast session or an MRB, and the RRC connection resume procedure is triggered in the case that: radio link quality of a serving cell of the UE is lower than or equal to the radio link quality threshold plus a corresponding offset value with respect to one multicast session of a multicast reception or with respect to one MRB of a multicast reception; or radio link quality of a serving cell of the UE is lower than or equal to the radio link quality threshold plus a corresponding offset value with respect to all multicast sessions of a multicast reception or with respect to all MRBs of a multicast reception. According to some embodiments of the present application, the at least one condition parameter further includes a state transition timer, and the RRC connection resume procedure is triggered in the case that: radio link quality of a serving cell of the UE is lower than or equal to the radio link quality threshold plus a corresponding offset value with respect to one multicast session of a multicast reception or with respect to one MRB of a multicast reception for a time interval of the state transition timer; or radio link quality of a serving cell of the UE is lower than or equal to the radio link quality threshold plus a corresponding offset value with respect to all multicast sessions of a multicast reception or with respect to all MRBs of a multicast reception for a time interval of the state transition timer. According to some embodiments of the present application, each of the at least one offset value is a hysteresis value.

In some embodiments of the present application, the at least one condition parameter includes at least one packet loss threshold, each of the at least one packet loss threshold is associated with a multicast session or an MRB, and the RRC connection resume procedure is triggered in the case that: a packet loss ratio of a multicast session of a multicast reception or an MRB of a multicast reception is higher or equal to a corresponding packet loss threshold. For example, the packet loss ratio is a number of missed protocol data convergence protocol (PDCP) packets counted in PDCP layer within a configured time length, or a packet error radio (PER) or block error ratio (BLER) counted in physical layer. In another example, the packet loss ratio is a number of PDCP re-ordering timer expiry counted in PDCP layer, and the corresponding packet loss threshold is a threshold of a number of PDCP re-ordering timer expiry.

In some embodiments of the present application, the at least one condition parameter is a timer, the timer is started by the UE in response to entering the RRC inactive state for multicast reception, and the RRC connection resume procedure is triggered in response to the timer expiring.

In some embodiments of the present application, the at least one condition parameter includes a multicast inactivity timer being started or restarted in response to receiving a media access control (MAC) service data unit (SDU) for multicast traffic channel (MTCH) logical channel by the UE in the RRC inactive state, and the RRC connection resume procedure is triggered in response to the multicast inactivity timer expiring.

In some embodiments of the present application, the at least one condition parameter further includes a connection prohibited timer, and triggering the RRC connection resume procedure is prohibited or evaluating whether the at least one condition parameter is fulfilled is prohibited in the case that the connection prohibited timer is running.

In some embodiments of the present application, the at least one condition parameter is configured via system information or RRC dedicated signaling.

In some embodiments of the present application, the RRC connection resume procedure is triggered with an access category defined for the RRC connection resume procedure triggered for multicast reception and a RRC cause for indicating the RRC connection resume procedure being requested due to multicast reception.

In some embodiments of the present application, the at least one processor is configured to stop or cancel evaluating whether the at least one condition parameter is fulfilled in response to: a RRC connection resume procedure being triggered by upper layer or by periodic radio access network (RAN)-based notification area (RNA) update or by response to a RAN paging; or a RRC connection setup procedure being triggered by response to a core network (CN) paging; or a RRC resume message being received; or a RRC setup message being received. According to some embodiments of the present application, the at least one processor may be configured to: release the configuration information on the at least one condition parameter in response to stopping or cancelling evaluating whether the at least one condition parameter is fulfilled.

In some embodiments of the present application, in response to a RRC reject message being received during the triggered RRC connection resume procedure, the at least one processor is configured to: re-initiate a RRC resume message after a configured time interval in the case that the at least one condition parameter is re-evaluated to be fulfilled. The at least one processor may be configured to: re-evaluate whether the at least one condition parameter is fulfilled upon receiving the RRC reject message or after a configured time interval from receiving the RRC reject message.

Embodiments of the present application can solve the technical problems occurring during RRC state transition in MBS, supporting multicast reception in RRC_INACTIVE state, and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a schematic diagram illustrating an exemplary scenario of RRC state transition for multicast reception according to some embodiments of the present application.

FIG. 3 is a flow chart illustrating an exemplary method of supporting MBS according to some embodiments of the present application.

FIG. 4 illustrates a block diagram of an exemplary apparatus of supporting MBS according to some embodiments of the present application.

FIG. 5 illustrates a block diagram of an exemplary apparatus of supporting MBS according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE), and so on. It is contemplated that along with the developments of network architectures and new service scenarios, all embodiments in the present application are also applicable to similar technical problems; and moreover, the terminologies recited in the present application may change, which should not affect the principle of the present application.

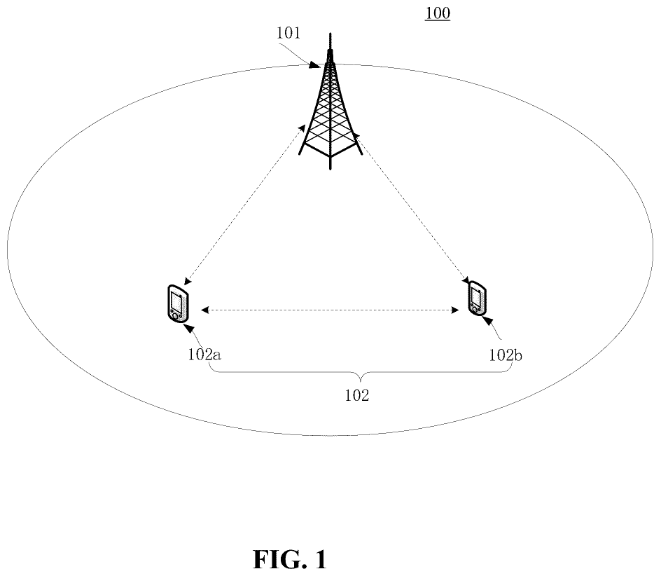

FIG. 1 illustrates a schematic diagram of an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

MBS was introduced to focus on a small area mixed mode multicast in NR R17, wherein multicast is only supported in RRC_CONNECTED state. Since hybrid automatic repeat request (HARQ) and point to multipoint (PTM)/point to point (PTP) dynamic switch are supported for high reliability, multicast reception in RRC_CONNECTED state can provide high quality of service (QoS) experience. That means, when UE being receiving multicast enters a non-connected state, e.g., RRC_INACTIVE state from RRC_CONNECTED state, it cannot continue receiving the multicast. The multicast reception will be interrupted. Thus, one potential objective of MBS in R18 is to support multicast reception in a non-connected state, e.g., in RRC_INACTIVE state, so that some UEs in RRC_CONNECTED state are receiving multicast or are configured to receive multicast can be released (or sent) to a non-connected state, e.g., RRC_INACTIVE state to at least relieve network congestion.

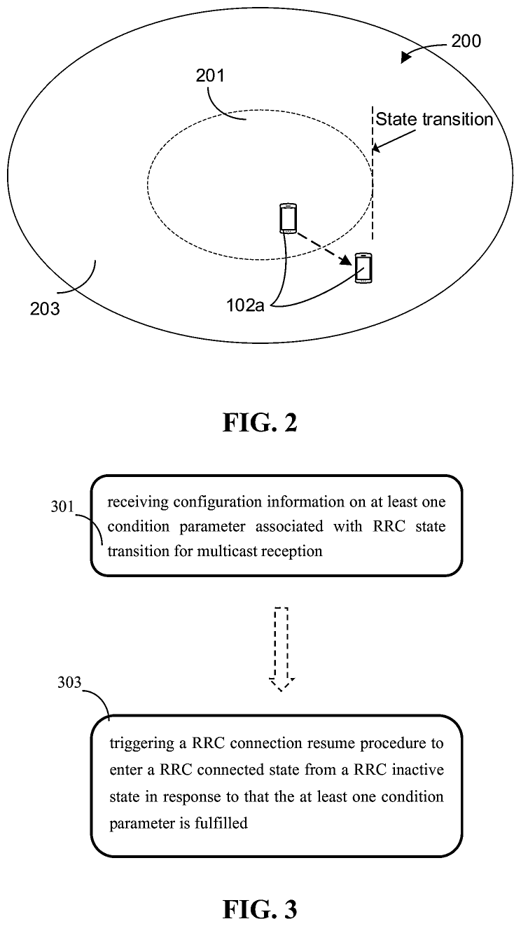

FIG. 2 is a schematic diagram illustrating an exemplary scenario of RRC state transition for multicast reception according to some embodiments of the present application.

As shown in FIG. 2, for a coverage 200 provided by a BS, e.g., the BS 101 shown in FIG. 1, it generally includes a good coverage area 201, e.g., the center area of the coverage 200; and a bad coverage area 203, e.g., the edge area of the coverage 200. Taking a UE, e.g., the first UE 102a shown in FIG. 1 as an example, it is supposed that the first UE 102a can receive multicast in both RRC_CONNECTED state and RRC_INACTIVE state. When the first UE 102a is located in the good coverage area 201 and is receiving multicast or is configured to receive multicast, the first UE 102a may be released to RRC_INACTIVE state by the BS to relieve network congestion in the coverage 200. That is, the first UE 102a is transited (or switched) from RRC_CONNECTED state to RRC_INACTIVE state. The first UE 102a can continue receiving the multicast in RRC_INACTIVE state. If the first UE 102a is still in the good coverage area 201 and has low mobility, the QoS experienced by the first UE 102a is likely to be similar to that in RRC_CONNECTED state.

However, when the first UE 102a moves to the bad coverage area 203 or when there is less or no more network congestion in the coverage 200, it would be better that the first UE 102a returns to RRC_CONNECTED state from RRC_INACTIVE state for better QoS experience of the multicast reception. Since the BS does not know the location of the first UE 102a in RRC_INACTIVE state and complete RAN Notification Area (RNA) may be needed for paging the first UE 102a, paging is not a good solution for the first UE 10a re-entering RRC_CONNECTED state. Thus, a novel technical solution is needed to support the first UE 102a or the like to re-enter RRC_CONNECTED state in such as a scenario.

At least for solving the above technical problem, embodiments of the present application propose an improved technical solution for MBS. For example, according to some embodiments of the present application, a method and apparatus of supporting MBS triggers UE receiving multicast to return to RRC_CONNECTED state from RRC_INACITVE state based on the coverage status (or radio link condition) while avoid ping-pong state transitions. According to some embodiments of the present application, a method and apparatus of supporting MBS triggers UE receiving multicast to return to RRC_CONNECTED state from RRC_INACITVE state based on the network congestion status or multicast data inactivity status. According to some embodiments of the present application, a method and apparatus of supporting MBS defines a new access category and resume cause for the RRC connection resume procedure triggered for multicast reception.

FIG. 3 is a flow chart illustrating an exemplary method of supporting MBS according to some embodiments of the present application, which can be performed by a UE in the remote side, e.g., by the first UE 102a or the second UE 102b shown in FIG. 1 or the like. It is supposed that the UE supports multicast reception in the RRC connected state and RRC non-connected state, e.g., the RRC inactive state.

When network congestion happens, the network side, e.g., a gNB may release (or send) the UE, that is in the RRC connected state and is receiving multicast or is configured to receive multicast, to the RRC inactive state, and configure the UE to continue receiving the multicast in the RRC inactive state. The network side may also configure at least one condition parameter so that the UE can enter (or re-enter, or return) the RRC connected state when the congestion relieves or disappears. That is, to trigger a UE that is receiving multicast or is configured to receive the multicast in a RRC inactive state (e.g., RRC_INACTIVE state) to re-enter a RRC connected state (e.g., RRC_CONNECTED state), at least one condition parameter associated with RRC state transition for multicast reception can be configured to the UE, e.g., by a gNB. As shown in FIG. 3, the UE will receive the configuration information on at least one condition parameter associated with RRC state transition for multicast reception in step 301. For example, the UE may receive the at least one condition parameter via system information, e.g., system information (SIB) or RRC dedicated signaling, e.g., RRCReconfiguration message or RRCRelease message.

The at least one condition parameter associated with RRC state transition for multicast reception can be configured in various manners. For example, in some embodiments of the present application, the at least one condition parameter associated with RRC state transition for multicast reception may be configured according to congestion status or radio link condition, e.g., including a radio link quality threshold and a state transition timer associated with the radio link quality threshold, or including a radio link quality threshold and at least one scaling factor associated with the radio link quality threshold etc. In some other embodiments of the present application, the at least one condition parameter associated with RRC state transition for multicast reception may be a timer, e.g., a timer started by the UE in response to entering the RRC inactive state for multicast reception, or a multicast inactivity timer being started or restarted in response to receiving an MAC SDU for MTCH logical channel by the UE in the RRC inactive state.

In some embodiments of the present application, to avoid ping-pong state transitions, the at least one condition parameter may include a connection prohibited timer. When the connection prohibited timer is running, evaluating whether the at least one condition parameter is fulfilled or triggering a RRC connection resume procedure is prohibited.

Based on the received configuration information on the at least one condition parameter, the UE that is receiving multicast or is configured to receive the multicast in the RRC inactive state, will evaluate whether the at least one condition parameter is fulfilled in the RRC inactive state. If the at least one condition parameter includes a connection prohibited timer which is configured to prohibit evaluating whether the at least one condition parameter is fulfilled, then evaluating whether the at least one condition parameter is fulfilled will be prohibited when the connection prohibited timer is running. In response to the at least one condition parameter is fulfilled, a RRC connection resume procedure may be triggered by the UE to enter the RRC connected state from the RRC inactive state in step 303. However, if the at least one condition parameter includes a connection prohibited timer which is configured to prohibit triggering a RRC connection resume procedure, then triggering the RRC connection resume procedure will be prohibited when the connection prohibited timer is running.

Evaluating whether the at least one condition parameter is fulfilled may be stopped or canceled in some scenarios. For example, evaluating whether the at least one condition parameter is fulfilled may be stopped or canceled in response to: a RRC connection resume procedure being triggered by upper layer or by periodic RNA update or by response to a RAN paging. In another example, evaluating whether the at least one condition parameter is fulfilled may be stopped or canceled in response to: a RRC connection setup procedure being triggered by response to a CN paging. In yet another example, evaluating whether the at least one condition parameter is fulfilled may be stopped or canceled in response to: a RRC resume message, e.g., RRCResume message being received. In yet another example, evaluating whether the at least one condition parameter is fulfilled may be stopped or canceled in response to: a RRC setup message, e.g., RRCSetup message being received. When evaluating whether the at least one condition parameter is fulfilled is stopped or canceled, the configuration information on the at least one condition parameter will be released.

In some embodiments of the present application, the UE will re-evaluate whether the at least one condition parameter is fulfilled upon receiving a RRC reject message, e.g., RRCReject message during a triggered RRC connection resume procedure or after a configured time interval from receiving the RRC reject message (i.e., the configured time expires). In the case that the at least one condition parameter is re-evaluated to be fulfilled, the UE may re-initiate a RRC resume message after the configured time interval.

Based on the above general description, more details will be illustrated in various embodiments hereafter, wherein different schemes are provided in view of different configuration information on the at least one condition parameter. Considering the consistency between the remote side and network side, although some demonstrations in the specification are provided mainly in the remote side, persons skilled in the art should clearly understand how to apply them in the network side.

### Scheme 1

In some embodiments of the present application, the at least one condition parameter includes a radio link quality threshold and a state transition timer associated with the radio link quality threshold. For example, the radio link quality threshold can be a reference signal received power (RSRP) threshold or a reference signal received quality (RSRQ) threshold. The state transition timer is provided mainly to avoid ping-pong state transitions. When the measured radio link quality, e.g., RSRP of a serving cell (or a cell) of the UE is lower than or equal to the radio link quality threshold for a time interval of the state transition timer (that is, the state transition timer expires), the UE will trigger a RRC connection resume procedure to enter the RRC connected state. That is, the UE will not trigger a RRC connection resume procedure when the state transition timer is running even if the radio link quality of the serving cell of the UE is lower than or equal to the radio link quality threshold.

The at least one condition parameter may further include a connection prohibited timer. When the connection prohibited timer is running, the UE will not evaluate whether the radio link quality of the cell of the UE is lower than or equal to the radio link quality threshold for a time interval of the state transition timer. Or, when the connection prohibited timer is running, even if the radio link quality of the cell of the UE is lower than or equal to the radio link quality threshold for a time interval of the state transition timer, the UE will not trigger a RRC connection resume procedure.

### Scheme 2

In some embodiments of the present application, at least one of the radio link quality threshold and state transition timer as recited in Scheme 1 can be used with a corresponding scaling factor, which may be network load dependent or UE mobility speed dependent.

For example, the at least one condition parameter may include: a radio link quality threshold and at least one scaling factor associated with the radio link quality threshold. The UE will evaluate whether the radio link quality of the cell of the UE is lower than or equal to the radio link quality threshold multiplied by the corresponding scaling factor. The UE will trigger a RRC connection resume procedure when the radio link quality of the serving cell of the UE is lower than or equal to the radio link quality threshold multiplied by the corresponding scaling factor.

The at least one condition parameter may further include a connection prohibited timer. When the connection prohibited timer is running, the UE will not evaluate whether the radio link quality of the cell of the UE is lower than or equal to the radio link quality threshold multiplied by a corresponding scaling factor or not trigger the RRC connection resume procedure, which depends on what is prohibited by the connection prohibited timer. Whatever, when the connection prohibited timer is running, even if the radio link quality of the cell of the UE is lower than or equal to the radio link quality threshold multiplied by a corresponding scaling factor, the UE will not trigger a RRC connection resume procedure.

In another example, the at least one condition parameter may include: a radio link quality threshold, a state transition timer and at least one scaling factor associated with the radio link quality threshold. The UE will evaluate whether the radio link quality of the cell of the UE is lower than or equal to the radio link quality threshold multiplied by a corresponding scaling factor for a time interval of the state transition timer. When the radio link quality of the serving cell of the UE is lower than or equal to the radio link quality threshold multiplied by the corresponding scaling factor for a time interval of the state transition timer, the UE will trigger a RRC connection resume procedure to enter the RRC connected state. However, when the at least one condition parameter includes a connection prohibited timer and the connection prohibited timer is running, the UE will not evaluate whether the radio link quality of the cell of the UE is lower than or equal to the radio link quality threshold multiplied by the corresponding scaling factor for a time interval of the state transition timer or not trigger the RRC connection resume procedure, which depends on what is prohibited by the connection prohibited timer.

In yet another example, the at least one condition parameter may include: a radio link quality threshold, a state transition timer and at least one scaling factor associated with the state transition timer. The UE will evaluate whether the radio link quality of the cell of the UE is lower than or equal to the radio link quality threshold for a time interval of the state transition timer multiplied by a corresponding scaling factor. When the radio link quality of the serving cell of the UE is lower than or equal to the radio link quality threshold for a time interval of the state transition timer multiplied by the corresponding scaling factor, the UE will trigger a RRC connection resume procedure to enter the RRC connected state. That is, the actual time interval of the state transition timer is changed to be a time interval (e.g., the original one) multiplexed by the corresponding scaling factor. However, when the at least one condition parameter includes a connection prohibited timer and the connection prohibited timer is running, the UE will not evaluate whether the radio link quality of the cell of the UE is lower than or equal to the radio link quality threshold multiplied by the corresponding scaling factor for a time interval of the state transition timer or not trigger the RRC connection resume procedure, which depends on what is prohibited by the connection prohibited timer.

In yet another example, the at least one condition parameter may include: a radio link quality threshold, at least one first scaling factor associated with the radio link quality threshold, a state transition timer and at least one second scaling factor associated with the state transition timer. The UE will evaluate the radio link quality of a serving cell of the UE is lower than or equal to the radio link quality threshold multiplied by a first scaling factor of the at least one first scaling factor for a time interval of the state transition timer multiplied by a second scaling factor of the at least one second scaling factor. When the radio link quality of the serving cell is lower than or equal to the radio link quality threshold multiplied by the first scaling factor for a time interval of the state transition timer multiplied by the second scaling factor, the UE will trigger a RRC connection resume procedure to enter the RRC connected state. However, when the at least one condition parameter includes a connection prohibited timer and the connection prohibited timer is running, the UE will not evaluate whether the radio link quality of the cell of the UE is lower than or equal to the radio link quality threshold multiplied by the first scaling factor for a time interval of the state transition timer multiplied by the first scaling factor or not trigger the RRC connection resume procedure, which depends on what is prohibited by the connection prohibited timer.

In addition, when the scaling factor is a network load dependent scaling factor, the scaling factor can be adjusted or updated according to network congestion status. For example, for a cell in a high load state, the scaling factor may be 1.5; and for a cell in a medium load state, the scaling factor may be 1.2. Accordingly, the network can control the UE to enter the RRC connected state according to the network load state, and UE in worse congestion status is supposed to enter the RRC connected state with a higher priority than UE with better congestion status.

For example, the at least one condition parameter may include a radio link quality threshold and a network load dependent scaling factor, e.g., 1.5. When evaluating whether the at least one condition parameter is fulfilled, the UE will evaluate whether the radio link quality of the serving cell of the UE is lower than or equal to a new threshold which is counted by multiplying the configured radio link quality threshold by 1.5. The UE will trigger a RRC connection resume procedure when the radio link quality of the serving cell of the UE is lower than or equal to the new threshold.

When the scaling factor is a UE mobility speed dependent scaling factor, the scaling factor can be adjusted or updated according to UE mobility speed. For example, for UE in a high mobility speed, the sailing factor may be 0.5; and for UE in a medium mobility speed, the scaling factor may be 0.8. Accordingly, UE in a higher mobility speed is supposed to enter the RRC connected state with a higher priority than UE in a lower mobility speed.

For example, the at least one condition parameter may include a radio link quality threshold, a state transition timer and a UE mobility speed dependent scaling factor associated with the state transition timer, e.g., 0.5. When evaluating whether the at least one condition parameter is fulfilled, the UE will evaluate whether the radio link quality of the serving cell of the UE is lower than or equal to the radio link quality threshold for a time interval of the state transition timer multiplied by 0.5. The UE will trigger a RRC connection resume procedure when the radio link quality of the serving cell of the UE is lower than or equal to the radio link quality threshold for a time interval of the state transition timer multiplied by 0.5.

### Scheme 3

In some embodiments of the present application, the radio link quality threshold as recited in Scheme 1 can be used with a corresponding offset value, which may be configured per MRB or per multicast session. That is, each MRB or multicast session has a corresponding at least one condition parameter. According to some embodiments of the present application, the offset value is a hysteresis value. Similarly, when the at least one condition parameter includes a connection prohibited timer and the connection prohibited timer is running, the UE will not evaluate whether the at least one condition parameter is fulfilled or not trigger the RRC connection resume procedure, which depends on whether it is prohibited by the connection prohibited timer.

When there are multiple MRBs or multiple multicast sessions, the UE may evaluate whether the at least one condition parameter is fulfilled based on the multiple MRBs or multiple multicast sessions. However, UE may trigger a RRC connection resume procedure to enter the RRC connected state when one of the multiple MRBs or multiple multicast sessions satisfies with the requirements (or criteria) provided by the corresponding at least one condition parameter, or when all of the multiple MRBs or multiple multicast sessions satisfy with the requirements (or criteria) provided by their respective at least one condition parameter.

For example, the at least one condition parameter may include: a radio link quality threshold and at least one offset value associated with the radio link quality threshold, each of the at least one offset value is associated with a multicast session or an MRB. For each MRB or multicast session, the UE will evaluate whether the radio link quality of a serving cell of the UE is lower than or equal to the radio link quality threshold plus a corresponding offset value.

In some embodiments of the present application, when there are multiple MRBs or multicast sessions in a multicast reception, the UE will trigger a RRC connection resume procedure to enter the RRC connected state when radio link quality of a serving cell of the UE is lower than or equal to the radio link quality threshold plus an offset value of one of the multiple MRBs or multiple multicast sessions. That is, the RRC connection resume procedure is triggered in the case that: radio link quality of a serving cell of the UE is lower than or equal to the radio link quality threshold plus a corresponding offset value with respect to one multicast session of a multicast reception or with respect to one MRB of a multicast reception (i.e., one MRB or multicast session satisfies with the requirement).

In some other embodiments of the present application, when there are multiple MRBs or multicast sessions in a multicast reception, the UE will trigger a RRC connection resume procedure to enter the RRC connected state in the case that for each MRB or each multicast session, radio link quality of a serving cell of the UE is lower than or equal to the radio link quality threshold plus a corresponding offset value. That is, the RRC connection resume procedure is triggered in the case that: radio link quality of a serving cell of the UE is lower than or equal to the radio link quality threshold plus a corresponding offset value with respect to all multicast sessions of a multicast reception or with respect to all MRBs of a multicast reception (i.e., all MRBs or multicast sessions should satisfy with the requirements).

Similar to Scheme 1 and Scheme 2, a state transition timer can also be used in Scheme 3. For example, the at least one condition parameter further includes a state transition timer, and the RRC connection resume procedure is triggered in the case that: radio link quality of a serving cell of the UE is lower than or equal to the radio link quality threshold plus a corresponding offset value with respect to one multicast session of a multicast reception or with respect to one MRB of a multicast reception for a time interval of the state transition timer; or radio link quality of a serving cell of the UE is lower than or equal to the radio link quality threshold plus a corresponding offset value with respect to all multicast sessions of a multicast reception or with respect to all MRBs of a multicast reception for a time interval of the state transition timer.

### Scheme 4

In some embodiments of the present application, the at least one condition parameter includes at least one packet loss threshold, each of the at least one packet loss threshold is associated with a multicast session or an MRB. That is, the packet loss threshold is per multicast session or per MRB. In an example, the packet loss ratio is counted in PDCP layer, e.g., a number of missed PDCP packets, e.g., protocol data units (PDU)s or SDUs counted in PDCP layer within a configured time length, or a number of PDCP re-ordering timer expiry counted in PDCP layer. When the packet loss ratio is a number of PDCP re-ordering timer expiry counted in PDCP layer, the corresponding packet loss threshold is a threshold of a number of PDCP re-ordering timer expiry. In another example, the packet loss ratio is counted in physical layer, e.g., a PER or BLER counted in physical layer.

The UE will evaluate whether a packet loss ratio of a multicast session of a multicast reception or an MRB of a multicast reception is higher or equal to a corresponding packet loss threshold. For example, the UE may evaluate whether a number of PDCP re-ordering timer expiry counted in PDCP layer is higher or equal to a threshold of a number of PDCP re-ordering timer expiry within a configured time. The RRC connection resume procedure will be triggered in the case that: a packet loss ratio of a multicast session of a multicast reception or an MRB of a multicast reception is higher or equal to a corresponding packet loss threshold.

Similarly, when the at least one condition parameter includes a connection prohibited timer and the connection prohibited timer is running, the UE will not evaluate whether the at least one condition parameter is fulfilled or not trigger the RRC connection resume procedure, which depends on what is prohibited by the connection prohibited timer.

### Scheme 5

In some embodiments of the present application, the at least one condition parameter is a timer. For example, the timer is a timer configured to be started by the UE in response to entering the RRC inactive state for multicast reception. The UE may trigger a RRC connection resume procedure in response to the timer expiring. In another example, the timer is a multicast inactivity timer being started or restarted in response to receiving an MAC SDU for MTCH logical channel by the UE in the RRC inactive state. The UE may trigger a RRC connection resume procedure in response to the multicast inactivity timer expiring. However, according to some embodiments of the present application, expiry of the multicast inactivity timer may not trigger the RRC connection resume procedure, and the UE will enter a RRC idle state.

An exemplary procedure based on the multicast inactivity timer is proposed as follows:

When dataInactivityTimer_RRC_INACTIVE is configured, the UE shall:
1>if in RRC_INACTIVE state with multicast reception:
   2>if any MAC entity receives a MAC SDU for MTCH logical channel of multicast; or
      3>start or restart dataInactivityTimer_RRC_INACTIVE.
   2>if the dataInactivityTimer_RRC_INACTIVE expires:
      3>indicate the expiry of the dataInactivityTimer_RRC_INACTIVE to upper layers.
1>Upon receiving the expiry of dataInactivityTimer_RRC_INACTIVE from lower layers while in RRC_INACTIVE, the UE shall:
   2>perform the RRC Resume procedure for returning to RRC_CONNECTED state. OR
2>perform the actions upon going to RRC_IDLE.

Considering that the state transition to the RRC connected state from the RRC inactive state is triggered by an access stratum (AS) triggered request, it is up to RRC layer determines the access category while non-access stratum (NAS) determines the access identity(ies). Embodiments of the present application propose a new access category, e.g. access category 9 for the RRC connection resume procedure triggered for multicast reception, and propose setting the RRC cause (or RRC resume cause) in RRCResuemeRequest message to “multicast call” to indicate the request is due to multicast reception.

An exemplary detailed procedure by using the new access category is as follows:

Upon initiation of the RRC Resume procedure, the UE shall:
1>if the resumption of the RRC connection is triggered by response to NG-RAN paging:
   2>select ‘0’ as the Access Category;
   2>perform the unified access control procedure as specified in 5.3.14 using the selected Access Category and one or more Access Identities provided by upper layers;
      3>if the access attempt is barred, the procedure ends;
1>else if the resumption of the RRC connection is triggered by upper layers:
   2>if the upper layers provide an Access Category and one or more Access Identities:
      3>perform the unified access control procedure as specified in 5.3.14 using the Access Category and Access Identities provided by upper layers;
         4>if the access attempt is barred, the procedure ends;
   2>set the resumeCause in accordance with the information received from upper layers;
1>else if the resumption of the RRC connection is triggered due to an RNA update as specified in 5.3.13.8:
   2>if an emergency service is ongoing:
   NOTE: How the RRC layer in the UE is aware of an ongoing emergency service is up to UE implementation.
      3>select ‘2’ as the Access Category;
      3>set the resumeCause to emergency;
   2>else:
      3>select ‘8’ as the Access Category;
   2>perform the unified access control procedure as specified in 5.3.14 using the selected Access Category and one or more Access Identities to be applied as specified in TS 24.501 [23];
1>else if the resumption of the RRC Connection is tiggered due to a multicast reception:
   2>select ‘9’ as the Access Category;
2>2>perform the unified access control procedure as specified in 5.3.14 using the selected Access Category and one or more Access Identities to be applied as specified in TS 24.501 [23];

An exemplary RRC resume cause is as follows:
Resume Cause
The IE ResumeCause is used to indicate the resume cause in RRCResumeRequest and RRCResumeRequest1.

ResumeCause information element

-- ASN1START
-- TAG-RESUMECAUSE-START

| | |
|---|---|
| ResumeCause ::= | ENUMERATED {emergency, highPriorityAccess, |

mt-Access, mo-Signalling,

mo-Data, mo-VoiceCall, mo-

VideoCall, mo-SMS, rna-Update, mps-PriorityAccess, mcs-PriorityAccess, mulitcast
reception, spare1, spare2, spare3, spare4, }
-- TAG-RESUMECAUSE-STOP
-- ASN1STOP

Embodiments of the present application also provide a solution of stopping or cancelling evaluating whether the at least one condition parameter is fulfilled.

For example, the UE may stop or cancel evaluating whether the at least one condition parameter is fulfilled when a RRC connection resume procedure is triggered either by upper layer or by periodic RNA update or by response to RAN paging.

In another example, the UE may stop or cancel evaluating whether the at least one condition parameter is fulfilled when a RRC Setup procedure is triggered in response to CN paging or when a RAN paging or CN paging is received.

In yet another example, the UE may stop or cancel evaluating whether the at least one condition parameter is fulfilled when RRCSetup or RRCResume message is received.

When a RRCReject message is received, the UE may re-initiate the RRCResume message after a configured time interval, e.g., by a configured timer, if the criteria of returning RRC the connected state for multicast reception is still fulfilled. When a RRCReject message is received, the UE may re-evaluate the criteria in response to receiving the RRCReject message or after the configured time interval (e.g., the configured timer expiries).

When the UE stops or cancels evaluating whether the at least one condition parameter is fulfilled (e.g., when a RRC connection resume procedure is triggered either by upper layer or by periodic RNA update or in response to RAN paging or when a RRC Setup procedure is triggered in response to CN paging or when a RAN paging or CN paging is received or when a RRCSetup or RRCResume message is received), the UE may release the configuration of the at least one condition parameter.

Besides the methods, embodiments of the present application also propose an apparatus of supporting MBS.

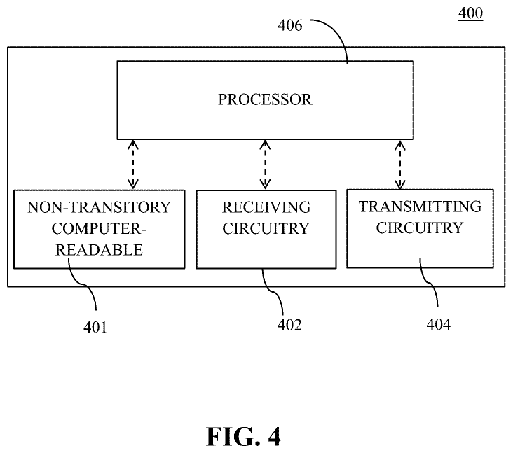

For example, FIG. 4 illustrates a block diagram of an apparatus of supporting MBS 300 according to some embodiments of the present application.

As shown in FIG. 4, the apparatus 400 may include at least one non-transitory computer-readable medium 401, at least one receiving circuitry 402, at least one transmitting circuitry 404, and at least one processor 406 coupled to the non-transitory computer-readable medium 401, the receiving circuitry 402 and the transmitting circuitry 404. The at least one processor 406 may be a CPU, a DSP, a microprocessor etc. The apparatus 400 may be a remote apparatus, e.g., a UE configured to perform a method illustrated in the above or the like.

Although in this figure, elements such as the at least one processor 406, transmitting circuitry 404, and receiving circuitry 402 are described in the singular, the plural is contemplated unless a limitation to the singular is explicitly stated. In some embodiments of the present application, the receiving circuitry 402 and the transmitting circuitry 404 can be combined into a single device, such as a transceiver. In certain embodiments of the present application, the apparatus 400 may further include an input device, a memory, and/or other components.

In some embodiments of the present application, the non-transitory computer-readable medium 401 may have stored thereon computer-executable instructions to cause a processor to implement the method with respect to the UE as described above. For example, the computer-executable instructions, when executed, cause the processor 406 interacting with receiving circuitry 402 and transmitting circuitry 404, so as to perform the steps with respect to the UE as illustrated above.

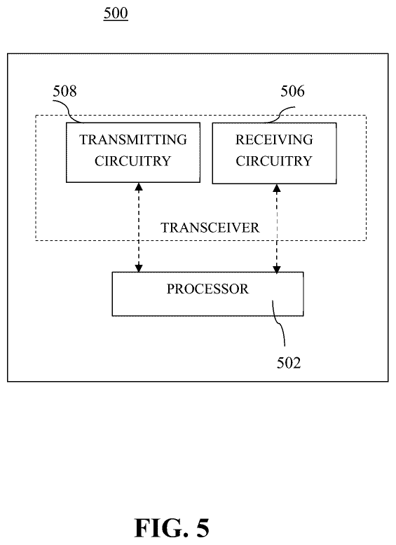

FIG. 5 is a block diagram of an apparatus of supporting MBS according to some other embodiments of the present application.

Referring to FIG. 5, the apparatus 500, for example a UE may include at least one processor 502 and at least one transceiver 504 coupled to the at least one processor 502. The transceiver 504 may include at least one separate receiving circuitry 506 and transmitting circuitry 508, or at least one integrated receiving circuitry 506 and transmitting circuitry 508. The at least one processor 502 may be a CPU, a DSP, a microprocessor etc.

According to some embodiments of the present application, when the apparatus 500 is a UE, the processor 502 is configured to: receive, via the at least one receiving circuitry 506, configuration information on at least one condition parameter associated with RRC state transition for a multicast reception; and trigger a RRC connection resume procedure to enter a RRC connected state from a RRC inactive state in response to that the at least one condition parameter is fulfilled in the case that the UE is receiving multicast or is configured to receive the multicast in the RRC inactive state.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
receive configuration information on at least one condition parameter associated with radio resource control (RRC) state transition for multicast reception; and
trigger an RRC connection resume procedure to enter an RRC connected state from an RRC inactive state in response to the at least one condition parameter being fulfilled when the UE is receiving multicast or when the UE is configured to receive the multicast in the RRC inactive state.

2. The UE according to claim 1, wherein, the at least one condition parameter comprises a radio link quality threshold and a state transition timer associated with the radio link quality threshold, and the RRC connection resume procedure is triggered when:
a radio link quality of a serving cell of the UE is lower than or equal to the radio link quality threshold for a time interval of the state transition timer.

3. The UE according to claim 1, wherein, the at least one condition parameter comprises: a radio link quality threshold, a state transition timer and at least one scaling factor associated with the radio link quality threshold, and the RRC connection resume procedure is triggered when:
a radio link quality of a serving cell of the UE is lower than or equal to the radio link quality threshold multiplied by a scaling factor of the at least one scaling factor for a time interval of the state transition timer, wherein, the scaling factor is network load dependent or is UE mobility speed dependent.

4. The UE according to claim 1, wherein, the at least one condition parameter comprises at least one packet loss threshold, wherein each packet loss threshold is associated with a multicast session or a multicast radio bearer (MRB), and the RRC connection resume procedure is triggered when:
a packet loss ratio of a multicast session of a multicast reception or an MRB of a multicast reception is higher or equal to a corresponding packet loss threshold.

5. The UE according to claim 1, wherein, the at least one condition parameter is a timer, wherein the timer is started by the UE in response to entering the RRC inactive state for multicast reception, and wherein the RRC connection resume procedure is triggered in response to the timer expiring.

6. The UE according to claim 1, wherein, the at least one condition parameter comprises a multicast inactivity timer being started or restarted in response to receiving a media access control (MAC) service data unit (SDU) for multicast traffic channel (MTCH-) logical channel by the UE in the RRC inactive state, and wherein the RRC connection resume procedure is triggered in response to the multicast inactivity timer expiring.

7. The UE according to claim 2, wherein, the at least one condition parameter further comprises a connection prohibited timer, and wherein triggering the RRC connection resume procedure is prohibited or evaluating whether the at least one condition parameter is fulfilled is prohibited when the connection prohibited timer is running.

8. The UE according to claim 1, wherein, the at least one processor is further configured to cause the UE to stop or cancel evaluating whether the at least one condition parameter is fulfilled in response to:
an RRC connection resume procedure being triggered by upper layer or by periodic radio access network (RAN)-based notification area (RNA) update or by response to a RAN paging;
an RRC connection setup procedure being triggered by response to a core network (CN) paging;
an RRC resume message being received; or
an RRC setup message being received.

9. A method performed by a user equipment (UE), the method comprising:
receiving configuration information on at least one condition parameter associated with radio resource control (RRC) state transition for multicast reception; and
triggering an RRC connection resume procedure by the UE to enter an RRC connected state from an RRC inactive state in response to the at least one condition parameter being fulfilled when the UE is receiving multicast or is configured to receive the multicast in the RRC inactive state.

10. The method according to claim 9, wherein, the at least one condition parameter comprises a radio link quality threshold and a state transition timer associated with the radio link quality threshold, and wherein the RRC connection resume procedure is triggered when:
a radio link quality of a serving cell of the UE is lower than or equal to the radio link quality threshold for a time interval of the state transition timer.

11. The method according to claim 9, wherein, the at least one condition parameter comprises: a radio link quality threshold, a state transition timer and at least one scaling factor associated with the radio link quality threshold, and wherein the RRC connection resume procedure is triggered when:
a radio link quality of a serving cell of the UE is lower than or equal to the radio link quality threshold multiplied by a scaling factor of the at least one scaling factor for a time interval of the state transition timer, wherein, the scaling factor is network load dependent or is UE mobility speed dependent.

12. The method according to claim 9, wherein, the at least one condition parameter comprises at least one packet loss threshold, wherein each packet loss threshold is associated with a multicast session or a multicast radio bearer (MRB), and wherein the RRC connection resume procedure is triggered when:
a packet loss ratio of a multicast session of a multicast reception or an MRB of a multicast reception is higher or equal to a corresponding packet loss threshold.

13. The method according to claim 9, wherein, the at least one condition parameter is a timer, wherein the timer is started by the UE in response to entering the RRC inactive state for multicast reception, and wherein the RRC connection resume procedure is triggered in response to the timer expiring.

14. The method according to claim 10, wherein, the at least one condition parameter further comprises a connection prohibited timer, and wherein triggering the RRC connection resume procedure is prohibited or evaluating whether the at least one condition parameter is fulfilled is prohibited in the case that the connection prohibited timer is running.

15. The method according to claim 9, further comprising: stopping or canceling an evaluation of whether the at least one condition parameter is fulfilled in response to:
an RRC connection resume procedure being triggered by upper layer or by periodic radio access network (RAN)-based notification area (RNA) update or by response to an RAN paging;
an RRC connection setup procedure being triggered by response to a core network (CN) paging;
an RRC resume message being received;
an RRC setup message being received.

16. A processor for wireless communication, comprising:
at least one controller coupled with at least one memory and configured to cause the processor to:
receive configuration information on at least one condition parameter associated with radio resource control (RRC) state transition for multicast reception; and
trigger an RRC connection resume procedure to enter an RRC connected state from an RRC inactive state in response to the at least one condition parameter being fulfilled when the processor is receiving multicast or when the processor is configured to receive the multicast in the RRC inactive state.

17. The processor according to claim 16, wherein the at least one condition parameter comprises a radio link quality threshold and a state transition timer associated with the radio link quality threshold, and the RRC connection resume procedure is triggered when:
a radio link quality of a serving cell of the processor is lower than or equal to the radio link quality threshold for a time interval of the state transition timer.

18. The processor according to claim 16, wherein the at least one condition parameter comprises: a radio link quality threshold, a state transition timer and at least one scaling factor associated with the radio link quality threshold, and the RRC connection resume procedure is triggered when:
a radio link quality of a serving cell of the processor is lower than or equal to the radio link quality threshold multiplied by a scaling factor of the at least one scaling factor for a time interval of the state transition timer, wherein, the scaling factor is network load dependent or is processor mobility speed dependent.

19. The processor according to claim 16, wherein the at least one condition parameter comprises at least one packet loss threshold, wherein each packet loss threshold is associated with a multicast session or a multicast radio bearer (MRB), and the RRC connection resume procedure is triggered when:
a packet loss ratio of a multicast session of a multicast reception or an MRB of a multicast reception is higher or equal to a corresponding packet loss threshold.

20. The processor according to claim 16, wherein the at least one condition parameter is a timer, wherein the timer is started by the processor in response to entering the RRC inactive state for multicast reception, and wherein the RRC connection resume procedure is triggered in response to the timer expiring.
